(19) United States
(12) Patent Application Publication
(10) Pub. No.: US 2025/0113834 A1
(43) Pub. Date: Apr. 10, 2025

(54) GRANULES MADE OF NATURAL INGREDIENTS FOR THE PRODUCTION OF WAFERS AND PASTRY PRODUCTS BY INJECTION MOLDING

(71) Applicant: HOPE TREE HOLDING GMBH, Geretsried-Gelting (DE)

(72) Inventor: LAMBERT DUSTIN DINZINGER, Geretsried-Gelting (DE)

(21) Appl. No.: 18/836,000

(22) PCT Filed: Feb. 7, 2023
(86) PCT No.: PCT/EP2023/052908

§ 371 Date: Aug. 5, 2024

(30) Foreign Application Priority Data
Feb. 7, 2022 (EP) 22155466.0

(51) Int. Cl. A21D 13/48; A21D 2/16; A21D 2/18; A21D 10/00; A21D 13/45; A21D 13/80

(52) U.S. Cl. CPC A21D 13/48; A21D 2/165; A21D 2/186; A21D 10/005; A21D 13/45; A21D 13/80

(57) ABSTRACT

The present invention relates to the provision of granules consisting of natural, preferably purely plant-based components. This granulate can be processed by injection molding without the addition of further components. Therefore, the invention also relates to the use of the granules in the injection molding process, as well as to products produced by processing the granules by injection molding, such as wafers in the form of carriers of food and dips, and pastry such as cookies. The present invention also relates to a method for the production of wafers and the production of cookies by injection molding

### CROSS-REFERENCE TO RELATED APPLICATIONS

This application is a national stage entry under 35 U.S.C. § 371 of International Patent Application PCT/EP2023/052908, filed Feb. 7, 2023 and published as International Patent Publication WO 2023/148392 A1 on Aug. 10, 2023, which claims the benefit of and priority to European Patent Application EP 22155466.0, filed on Feb. 7, 2022, the contents of each are hereby incorporated by reference.

### FIELD OF THE INVENTION

The present invention is in the field of natural, preferably purely plant-based granules. This granulate can also be used for the production of wafers and pastries in the form of carriers for food and dips in the injection molding process. The granulate consists of natural, preferably purely plant-based components, which means that both the granulate and the products are biodegradable and preferably also compostable. An example of a wafer product is a cup for holding chips/fries or an ice cream cup. An example of a pastry is a biscuit/cookie. The products can only be injection molded using this special granulate. There is therefore no limit to the shape of the end product. The end products have a wafer-like or biscuit-like consistency and are edible. The granules comprise a certain proportion of plant-based starch, plant-based flour and fat and/or oil, as well as optional additives such as sugar, salt, magnesium stearate, soy lecithin, sweeteners, baking soda or caramel. Optionally, the color of the granules or product can be modified by adding natural food coloring suitable for food, and/or the smell and/or taste of the granules or product made therefrom can be modified by adding natural aromas and/or flavorings.

### BACKGROUND OF THE INVENTION

In Germany alone, thousands of waffles and cookies are produced every day, such as ice cream waffles, but also wafer-like waffles as carriers for food and dips, such as chips bowls or ice cream bowls. Compared to plastic plates or paper plates with a plastic coating, edible products such as wafers are popular because they are biodegradable and can usually be eaten. Waver cups/waffle cups are therefore used as edible disposable tableware, especially for “out-of-home sales” in ice cream parlors and at ecologically oriented events. In some fish or meat stores, remoulade, ketchup, mayonnaise, mustard or other dips, e.g. with fish and chips or fries, are served in small waffle cups. Waffles are also the most common carrier of ice cream, which is often offered in cone-shaped waffles but also in waffles in the form of ice cream bowls.

At first glance, such conventional waffles/wafers as a carrier for food and dips seem fundamentally sustainable. However, the production process for such conventional wafers requires a lot of energy and gas, which ultimately makes the waffle product produced much less sustainable than assumed. When baking waffles/wafers and cookies, a doughy mass is often applied to molded baking plates and, due to the intentionally porous structure, “foamed” between two baking plates during the baking process with the addition of gas and/or the use of strong leavening agents. The disadvantages of conventionally produced wafers are the high consumption of gas and electricity and the associated price increase. Furthermore, only a small number of wafers can be produced in parallel and production times are long. The natural gas used for baking is a fossil fuel and releases climate-damaging carbon dioxide (CO₂) when burned. Every additional ton of this heats up the earth further. In order to combat the climate crisis, it is imperative to do without fossil fuels altogether.

In addition, large quantities of methane are escaping into the atmosphere through leaks in oil and gas production facilities and pipelines. Methane is the main component of natural gas and is extremely harmful to the climate. Over a 20-year period, every ton of methane heats up the earth 84 times more than the same amount of carbon dioxide. In 2020, for example, around seventy million tons of methane were released worldwide.

It is therefore necessary not only to provide waffles as biodegradable carriers for food and dips such as bowls and cups, but also to make their production as ecological and environmentally friendly as possible. The same applies to the production of baked goods such as cookies/biscuits. The present invention makes this contribution.

### SUMMARY OF THE INVENTION

The present invention relates to the provision of granules consisting of natural, preferably purely plant-based/plant-based components. This granulate can be processed by injection molding without the addition of further components. Therefore, the invention also relates to the use of the granules in the injection molding process, as well as to products produced by processing the granules by injection molding, such as wafers in the form of carriers of food and dips, and pastries such as cookies. The present invention also relates to a method for the production of wafers and the production of cookies by injection molding.

The granules of the present invention consist of natural, preferably purely plant-based ingredients comprising plant-based starch and plant-based flour. The granules have the following solid composition:

| | | |
|---|---|---|
| plant-based starch | 20-65 | wt % |
| plant-based flour | 10-55 | wt % |
| plant-based fat | 0.5-7 | wt % |
| and/or plant-based oil | | |
| optional additives | 0-35 | wt % |

wherein the ratio of plant-based starch to plant-based flour is 1:1.6-1:5 or 1.6:1-5:1 and wherein the granules have a residual moisture content of 10-50%, preferably 12-25%.

In a preferred embodiment, the total amount of plant-based starch and plant-based flour is at least 65% by weight of the total mass of solids.

In a preferred embodiment, the ratio of plant-based starch to plant-based flour is 1:2.5 or 2.5:1.

The plant-based starch is a native starch and comprises wheat starch, potato starch, corn starch, tapioca starch or starch from cassava, tuberous bean, batate, yam, tuberous pawpaw, arakacha, tuberous wood sorrel, tuberous nasturtium, ulluco, East Indian arrowroot, arrowroot, achira, taro, tannia, white water lily, yellow water lily or chayote, sweet potato starch, gesture starch, rye starch, sorghum starch, tritichale starch, modified starch, or a mixture thereof; preferably wheat starch, potato starch, corn starch, rice starch, tapioca starch or a mixture thereof.

The plant-based flour comprises wheat flour, rice flour, spelt flour, rye flour, barley flour, oat flour, millet flour, tapioca flour, almond flour, guar gum flour, carob flour, buckwheat flour, soy flour, amaranth flour, soy flour, or a mixture thereof.

The plant-based fat and/or oil comprises nut oil, olive oil, rapeseed oil, walnut oil, corn oil, almond oil, sesame oil, linseed oil, avocado oil, peanut oil, palm oil, pumpkin seed oil, grape seed oil, wheat seed oil, hemp oil, safflower oil, agran oil, corn oil, hazelnut oil, pistachio oil, walnut oil, poppy seed oil, macadamia oil, seasoning oil, mustard oil, truffle oil, sunflower oil, coconut oil, palm fat, palm kernel fat, sunflower fat, rapeseed fat, or coconut fat, or a mixture thereof. The plant-based fat and/or oil is preferably hydrogenated plant-based fat and/or hydrogenated plant-based oil. The plant-based oil is preferably cold-pressed oil.

The optional additives may comprise sugar, sweeteners comprising xylitol, oligofructose, apple extract, skimmed milk powder, milk (preferably vegan), citric acid, whole egg powder (preferably vegan), salt, sodium bicarbonate, magnesium stearate, caramel, soy lecithin, or the enzyme Preventase, or a mixture thereof. Other optional additives include one or more food grade colorants, natural flavors and/or flavorings.

The granules according to the invention do not comprise bioplastics, biobased plastics or petroleum-based biopolymers.

In a further aspect, the invention relates to the use of the granules according to the invention in an injection molding process.

In a further aspect, the invention relates to the use of the granules according to the invention for the production of wafers and cookies. Wafers and cookies are produced by injection molding.

In still another aspect, the invention relates to a method for the production of carriers of food and dips in the form of wafers as well as the production of cookies, wherein the method is an injection molding method and wherein the granules according to the invention are the starting material for the injection molding method, comprising the steps of
a) filling the granules according to the invention into the injection molding machine,
b) injection molding the mass into a desired shape.

In a preferred embodiment, the granules according to the invention are the sole starting material for the process according to the invention. Sole starting material means that, apart from the granules, no other components are used to produce a wafer or a cookie of the present invention. Optionally, however, natural aromas, flavorings and/or natural food-safe colorings can be added to the granules in step a).

In a further aspect, the invention relates to carriers of food and dips in the form of wafers and/or pastries produced by the injection molding process according to the invention. The invention therefore relates to wafers and pastries produced by the process according to the invention.

In a further aspect, the invention relates to carriers of food and dips in the form of wafers or cookies having a solids content consisting of:

| | | |
|---|---|---|
| Plant-based starch | 20-65 | wt % |
| Plant-based flour | 10-55 | wt % |
| Hardened plant-based fat | 0.5-7 | wt % |
| and/or plant-based oil | | |
| optional additives | 0-35 | wt % |

wherein the ratio of plant-based starch to plant-based flour is 1:1.6-1:5 or 1.6:1-5:1.

In a preferred embodiment, the total amount of plant-based starch and plant-based flour in the carrier of meals and dips is at least 65% by weight of the total mass.

In a preferred embodiment, the ratio of plant-based starch to plant-based flour in the food and dip carrier is 1:2.5 or 2.5:1.

The optional additives may comprise sugar, sweeteners comprising xylitol, oligofructose, apple extract, skimmed milk powder, milk (preferably vegan), citric acid, whole egg powder (preferably vegan), salt, sodium bicarbonate, plant-based stearates preferably magnesium stearate, caramel, soy lecithin, or the enzyme preventase, or a mixture thereof. Other optional additives include one or more food grade colorants, natural flavors and/or flavorings.

The plant-based starch is a native starch and includes wheat starch, potato starch, corn starch, tapioca starch or starch from cassava, tuberous bean, batate, yam, tuberous pea, arakacha, tuberous wood sorrel, tuberous nasturtium, Ulluco, East Indian arrowroot, arrowroot, achira, taro, tannia, white water lily, yellow water lily or chayote, or a mixture thereof, preferably wheat starch, potato starch, corn starch, rice starch, tapioca starch or a mixture thereof.

The plant-based flour comprises wheat flour, rice flour, spelt flour, rye flour, barley flour, oat flour, millet flour, tapioca flour, almond flour, guar gum flour, locust bean flour, or a mixture thereof.

The invention further relates to wafers and/or pastries produced by the method according to the invention.

In one embodiment, the wafer is a carrier of food and/or dips.

The carrier of food and dips according to the invention in the form of wafers or the pastry is edible. The wafers and pastries can taste either sweet or salty.

The granules and the food and dip carrier in the form of wafers or pastries according to the invention are fully biodegradable and even more preferably compostable.

In one embodiment, the food and dip carrier in the form of wafers or cookies according to the invention can have any shape that can be produced by injection molding. Thus, the carrier may have the shape of an ice cream cone, and/or a shape suitable for the transportation of food, meals and dips, comprising the shape of a plate, a bowl, a cup, a chip tray, or a dessert tray. The cookie may have a conventional shape, e.g. flat cookies such as butter cookies, but also and preferably 3D-shaped cookies, for example in the shape of a three-dimensional animal, can be injection molded using the provided granules.

In a preferred embodiment, the pastry according to the invention is a cookie/buiscuit.

### Advantages of the Invention

Conventional plastic granulate is the typical delivery form of thermoplastics from raw material manufacturers for the plastics processing industry, especially for the injection molding process. Due to its pourability, it is a bulk material like sand or gravel and therefore just as easy to portion and transport. The granulate of the present invention consists of purely natural constituents, but shares the positive property of being presented as a granulate with that of plastic granulates. The material used in the present invention can be easily processed into any type of granulate or bulk material and the subsequent further processing of the granulate is also straightforward.

The granules of the present invention, their use in the injection molding process, the injection molding process according to the invention and the wafers and cookies produced in this way from the granules according to the invention also prove to be advantageous in many respects.

By using the plant-based raw materials starch (e.g. potato starch), plant-based flour (e.g. wheat flour), plant-based hardened fat (e.g. coconut fat), as well as the optional additives such as sweeteners, the granules, as well as the products of the present invention produced therefrom, are easily recyclable, completely biodegradable and naturally compostable, in contrast to conventional plastic products in the field of disposable tableware and packaging.

By using the vegetable raw materials starch (e.g. potato starch), vegetable flour (e.g. wheat flour), vegetable hardened fat (e.g. coconut fat), as well as the optional additives such as sweeteners, the granules, as well as the products of the present invention produced therefrom, are easily recyclable, completely biodegradable and naturally compostable, in contrast to conventional plastic products in the field of disposable tableware and packaging. The composting time of a tray made from granules according to the invention is less than 50 days, preferably less than 30 days. An optional coating (e.g. a plant-based wax coating) of the trays extends the composting process by only a few days, so that even coated carriers of food and dips made from granules of the present invention can be composted within 4-8 weeks. Furthermore, the granules of the present invention and the products made from them are compostable according to EN 13432, version 2000-12. The granules and the articles of daily use produced therefrom are also garden compostable. In addition, the granules and the products made therefrom are ultra-compostable, i.e. composted in less than 50 days. This does not apply, for example, to bioplastics such as PLA.

The plant-based starch and the plant-based flour are used as a natural product, i.e. in a natural, unmodified and untreated form, and are not chemically modified during the manufacturing process for granules. This protects the environment and makes the granules even more natural. The extrudate produced in the manufacturing process, which is dried and cut into granules, is also not chemically/physically treated to solidify and/or stabilize it.

Furthermore, the present granulate does not include bioplastics, biobased plastics or petroleum-based biopolymers. Bioplastics are understood to be all biopolymers that are obtained by chemically modifying natural and/or plant-based raw materials. Certain petroleum-based polymers are also biodegradable and are therefore “biopolymers” by definition. Petroleum-based polymers include polyvinyl alcohol (PVA), polybutylene adipate terephthalate (PBAT), polybutylene succinate (PBS), polycaprolactone (PCL) and polyglycolide (PGA). Petroleum-based polymers are not used here and are not a component of the granules or the wafers or cookies made from them. Bio-based plastics produced by extensive chemical modification of biological raw materials (e.g. polylactides (PLA) made from lactic acid produced using white biotechnology) are not included in the granules or the articles of daily use made from them. Furthermore, in addition to polylactide (PLA), polyhydroxyalkanoates (PHA), polyhydroxybutyrate (PHB), epoxyacylates and lignin-based substances such as thermoplastics are also considered to be bio-based plastics. None of these are covered by the present invention.

By using the granulate, the production process of a biodegradable and compostable food and dip carrier in the form of a wafer is energy-saving and time-efficient. As explained at the beginning, the production of conventional biodegradable carriers for food and dips, such as (chip) trays made from wafer dough, requires a lot of energy due to long, low-yield production cycles. In addition, the use of gas releases CO₂. Injection molding machines are operated electrically and, through suitable machine settings, not only open up a large savings potential in terms of costs, but also with regard to the natural gas required and the greenhouse gases generated as a result. Preferably, green electricity can be used. In addition, the purchase prices for the materials and machines used to produce wafers are four times higher in relation to the output produced than with the injection molding process. In addition, conventional wafer machines take up considerably more space. Electric injection molding machines consume only around a tenth of the energy of conventional press waffle machines and emit considerably less CO₂. The same applies to the production of baked goods such as cookies.

By applying the manufacturing process described herein using the granulate according to the invention, fast and therefore optimal process cycle times of 6-90 seconds, on average 30 seconds, can be achieved from filling the granulate to removing the product from the injection mold. The granulate provided can easily be used in combination with a vacuum filler. Automatic filling of the injection molding machine then enables a machine runtime of 24 hours per day. The number of wafers/biscuits that can be produced per cycle depends on the size and clamping force of the injection molding machine—a 300-ton injection molding machine from Wittmann Battenfeld, for example, can produce 36 wafers in the form of ice cream bowls in one process cycle.

A dough usually used for the production of wafers and pastries, which is clearly liquid, could not be processed by the plasticizing unit of the injection molding machine. Such a dough would not even be fed into the machine. In addition, the use of a liquid dough would not offer any process reliability compared to the granulate available due to a high error rate, which leads to losses. For the production of wafers and cookies by injection molding, it is essential to use the granulate provided with its specified residual moisture.

The amount of residual moisture influences the density of the product produced and its wall thickness. The products can be manufactured with a high density using the injection molding process. A wall thickness with a high density offers an advantage in terms of product stability. This also saves material, which has a positive effect on the ecological balance and the price of the end product. It also determines the air holes in the material. However, this also depends on the heat supplied in the channel and the respective shape. If a product is to be produced that has more air spaces, less material is required during injection as this expands in the mold. In addition, a venting channel ensures the escape of vapors, which is an essential part of a safe production process. If this is not guaranteed, the mold is not filled optimally. This leads to holes, cracks or an uneven fill level. Residual moisture in the granulate can also cause differences in the product produced and lead to considerable time savings in the cycle times of the molding process. Nevertheless, it should be mentioned that a certain amount of water is necessary to guarantee compaction and homogenization of the granulate. There must also be a certain amount of water in the granulate in order to guarantee various advantages such as surface quality, flow properties and uniformity when creating the product.

In addition, there are no limits to the shapes of the injection-molded wafers and injection-molded cookies. This means that any desired shape can be realized, such as three-dimensional animal cookies, which are visually very different from existing animal cookies, which always have a flat underside.

### BRIEF DESCRIPTION OF THE DRAWINGS

FIG. 1: Example of a food and dip carrier according to the invention. FIG. 1a shows an ice cream cup in oblique plan view. FIG. 1b shows the underside of this ice cream cup from an oblique top view. The injection point of the mold is still slightly visible. FIG. 1c shows the ice cream cup in different colors. This is achieved by adding food-safe coloring to the granulate when it is filled into the injection molding machine. Alternatively, the granulate itself can be colored.

FIG. 2: Exemplary design of food carriers. Shown is a cup for sauces and dips.

FIG. 3: Exemplary three-dimensional pastry.

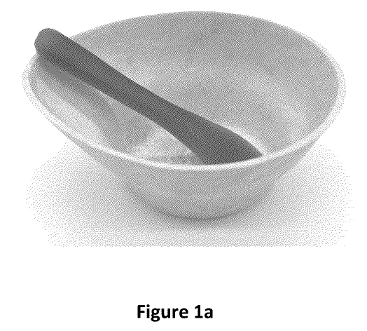

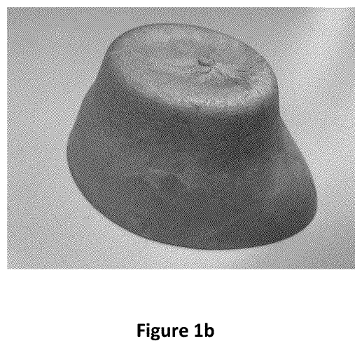

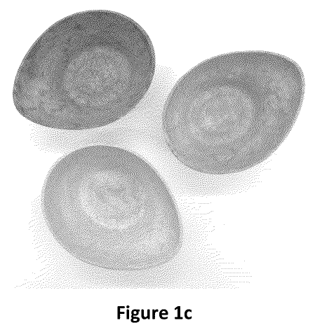

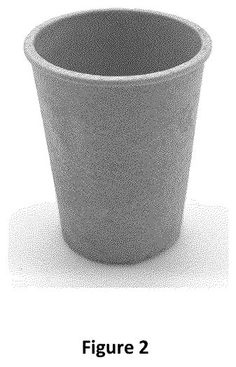

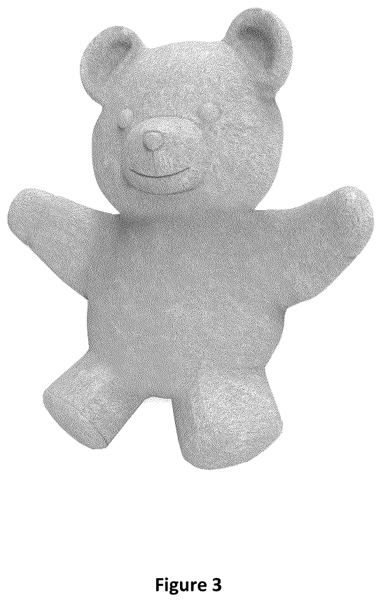

### DETAILED DESCRIPTION OF THE INVENTION

### Preparation of the Granules

First, all dry and liquid components are weighed, mixed together and then kneaded until a homogeneous mass is formed. This can be fed to an extruder in a variety of ways. The solid dough produced can, for example, be fed via an automatic feeder (AZ), which feeds the dough into the feed zone of the extruder in the form of a hopper in conjunction with a screw. The dough can also be portioned as “sausage”, “ball” or “flakes” or “pellets” or similar in order to guarantee problem-free feeding. The granulate is transported forwards by the auger and homogenized at the same time. Any type of screw such as single, double or special single-shaft extruders or co-kneaders can be used. Optionally, the water can then be removed from the mass in the degassing zone before forming. This takes place in the decompression zone, where a degassing dome/chamber/valve is installed. The mass is now formed into strands via nozzles and cooled using air. A rotating knife then cuts the strands into sections just a few millimetres long. Alternatively, the strands can be cut directly with a rotating blade at the nozzle or nozzles and the cuts can then also be dried in the air. The granulate produced can now be transported in pipelines or packed in bags or other containers.

The residual moisture of the granules determines the density of the final product produced.

The present invention also relates to a process for producing the granules according to the invention, wherein the process comprises the following steps:
a) preparing a mixture comprising flour, starch, fat and water and optionally one or more of the additives comprising sugar, salt, magnesium, soy lecithin, sweetener, baking soda, caramel, glycerin, plant-based fibers from wheat, bamboo, plant-based stearates, optionally comprising admixture of waxes.
b) forming the mixture from a) into a strand in an extruder machine,
c) cutting the strand produced in b) into granules;
d) curing the pellets produced in step c).
e) optionally: dehumidifying the granules produced in step c).
f) optionally: moistening the granules produced in step c) before further processing into a product by injection molding.

The present invention also relates to an alternative of the process described above for producing the granules according to the invention, wherein step d) is carried out before step c). The process then comprises the following steps:
a) preparing a mixture comprising flour, starch, fat and water and optionally one or more of the additives comprising sugar, salt, magnesium, soy lecithin, sweetener, sodium bicarbonate, caramel, glycerin, plant-based fibers from wheat, bamboo, plant-based stearates, optionally comprising the admixture of waxes.
b) forming the mixture from a) into a strand;
c) curing the strand produced in step b);
d) cutting the strand cured in c) into granules.

Specific compositions of the mixture from step a) for the preparation of the granules according to the invention:

In the present invention, the term “flour” refers to the entire powder that is produced when the respective cereal grains are finely milled. Accordingly, the “starch” used herein differs from the flour used herein in that “starch” is used in its pure form whereas “flour” means the totality of all components of the ground grains, comprising their starch. The solid composition of the granules according to the invention thus comprises plant-based starch and plant-based flour, wherein the plant-based starch is present in isolated pure form and wherein the flour is present as the entire yield of the milled grain. Moreover, the term ,,plant-based” is interchangeable with ,,vegetable” or ,,plant” and means that the respective material is entirely derived from a plant.

### Variant A:

Starch: 5 kg
Wheat flour: 2 kg
Sugar: 1 kg
Coconut fat: 50 g
Salt: 150 g
Baking soda: 40 g
Magnesium stearate: 10 g
Caramel: 10 g
Water: 4 Liter

### Variant B:

Starch: 2 kg
Wheat flour: 5 kg
Sugar: 1.5 kg
Coconut fat: 500 g
Salt: 100 g
Baking soda: 20 g
Magnesium stearate: 10 g
Caramel: 15 g
Water: 4.4 Liter

### Variant C:

Starch: 2 kg
Wheat flour: 5 kg
Soy lecithin 0.4 kg
Sugar: 1.5 kg
Coconut fat: 500 g
Salt: 100 g
Baking soda: 20 g
Magnesium stearate: 10 g
Caramel: 15 g
Water: 4,4 Liter

### Variant D:

Starch: 2 kg
Wheat flour: 5 kg
Soy lecithin: 0.4 kg
Sugar: 1.5 kg
Coconut fat: 500 g
Salt: 100 g
Baking soda: 20 g
Magnesium stearate: 10 g
Caramel: 15 g
Water: 5 Liter

### Variant E:

Starch: 2 kg
Wheat flour: 5 kg
Soy lecithin 0.4 kg
Sugar: 1.5 kg
Coconut fat: 400 g
Salt: 150 g
Baking soda: 20 g
Magnesium stearate: 10 g
Caramel: 10 g
Preventase: 0.08 kg
Water: 5 Liter

### Variant F:

Starch: 4 kg
Wheat flour: 1 kg
Soy lecithin 0.4 kg
Sugar: 1.5 kg
Coconut fat: 500 g
Salt: 100 g
Baking soda: 20 g
Magnesium stearate: 10 g
Caramel: 15 g
Almond Milk: 5 Liter

### Variant G:

Starch: 6 kg
Wheat flour: 3 kg
Soy lecithin 0.4 kg
Sugar: 1.5 kg
Coconut fat: 400 g
Salt: 150 g
Baking soda: 20 g
Magnesium stearate: 10 g
Caramel: 10 g
Preventase: 0.08 kg
Water: 5 Liter

### Variant H:

Starch: 5 kg
Wheat flour: 2 kg
Xylitol: 1 kg
Coconut fat: 400 g
Salt: 150 g
Baking soda: 40 g
Magnesium stearate: 10 g
Caramel: 10 g
Milk: 4 Liter

In step a), the components of the mixture are mixed. This is done with a mixer, which stirs the mixture into a homogeneous mass. The mixture can optionally also include glycerin, plant-based fibers, preservatives, flavors, flavorings, wax (preferably carnauba or soy wax), natural rubber (preferably as an emulsion or powder), plant-based stearate (preferably magnesium stearate), oil (preferably nut oil), lecithins. All powdery, fibrous and liquid components should first be mixed separately before all components are mixed. This avoids clumping and thus improves mixing of the individual ingredients.

In step b), the mixture from step a) is formed into one or more strands. In one embodiment, this is done by feeding the powdery to viscous mass directly into an extruder. This may be a single or twin extruder or similar extruders. In a preferred variant, the mass produced can be compacted with a thermoplastic screw and plasticized with the addition of energy. Both a thermoplastic screw and a conveying screw can be used. The result is a homogeneous mixture. In one embodiment, the homogeneous mixture is granulated by feeding it through the optionally heated screw conveyor to nozzles and forcing it through them. In this way, the mixture is granulated into granules. In one embodiment, the strands are then optionally cooled using fans and dehumidified and dried using dehumidifiers. In another embodiment, the strands are cooled and dried using compressed air. In another embodiment, the strands are cut directly with a rotating blade and then cooled and dried. This prevents the individual granules from sticking together.

In step c), the strands from step b) are cut into pellets. Optionally, the blades used for this are cooled with water. This produces granules in the form of beads or lenses.

In step d), in preferred embodiments, the granulate is then dried or hardened until it is completely dry. This can be done, for example, by drying using aeration/ventilation or a dehumidifier or the like. In some embodiments, the product is introduced into a “cooling and cutter” machine where it is dried by fans and thereby cured. In some embodiments, the curing takes place by means of heat. This can be done as an alternative or in addition to curing by ventilation. In some embodiments, curing is carried out using heat in a heating tunnel. The temperature range here is between 25° C. and 140° C., preferably between 45° C. and 120° C., more preferably at 85° C. In some embodiments, curing is carried out by means of a dehumidifier.

In an alternative embodiment of the invention, after step b) the strand is first dried as a whole and only then, in an already solid state, is it cut into the desired length of granules. The solidification can take place, for example, in a drying tunnel or using fans. The granulate of this embodiment is cube-, bead- or cylinder-shaped.

In further embodiments, the granules are refined by incorporating plant-based waxes, making them more resistant to water and oil.

In further embodiments, the granules are made more resistant to mold by incorporating preservatives and the expiry date is extended.

In further embodiments, the granules are refined by introducing fragrances and flavors.

In further embodiments, the granules are refined by incorporating plant-based fibers in order to produce products that are more stable and more resistant to tearing and abrasion.

The process for producing the granules can optionally comprise further steps. For example, dyes can be added to the mixture from a) to obtain a colored granulate. In preferred embodiments, the colorants used are plant-based colorants.

The process for producing the granules may optionally comprise further steps. For example, fragrances may be added to the mixture of a) to obtain a good smelling granule. In preferred embodiments, the fragrances used are plant-based colorants.

In some embodiments, the method comprises irradiating the granules or product with UV light for sterilization.

### Production of Products by Injection Molding

The granules may subsequently be injection molded to form, for example, wafers as disclosed herein comprising carriers of food and dips such as disposable tableware, and cookies comprising cookies by injection molding.

### Injection Molding:

Almost all sizes and shapes of parts can be injection molded. For example, a screw plasticizing unit is used to plasticize the mass, whereby the screw moves slowly backwards during the compression process and forms a melt cushion in front of the screw tip. Once the quantity required for a part has been reached, the screw moves forward and presses the melt/compound through the heated nozzle and through sprue channels under pressure into the cavity of the cold or hot mold, the so-called tool. The mass now cools down in the mold or bakes out and is ejected as a ready-to-use “molded part”.

The granulate should have a maximum residual moisture content of 50%, otherwise it will be difficult for the plasticizing unit to absorb. The optimum residual moisture is preferably between 12-25%, as this gives the wafer or cookie to be produced a firm bite and thus brings out the crispy effect. However, the residual moisture should not be less than 10%, otherwise the product will be slightly brittle. The residual moisture of the granules is essential for the density and stability of the product produced.

The granulate is fed into the injection molding machine via a hopper and drawn in via the plasticizing unit. In the plasticizing unit of the injection molding machine, the granulate is then homogenized and compacted by kinetic heat and then injected into the desired mold at high pressure. The screw should be a screw conveyor and can be heated to 70° C. to reduce the molding and baking cycle time. In some cases, depending on the injection flow, the screw conveyor requires a non-return valve to prevent the material from shooting out due to water evaporation. The mold should be heated between 140° C. and 220° C., depending on the wall thickness and shape of the product to be produced.

The injected mass is then baked in the injection mold. The baking time in the injection mold should be a minimum of 10 seconds and a maximum of 2 minutes. The optimum baking time is between 20-45 seconds. However, it should be mentioned that the wall thickness of the product produced has an essential effect on the baking time. The thicker the wall thickness, the longer the baking time. The baking temperature is preferably between 120-250 degrees. Particularly preferably between 160-220 degrees. Since the applied temperature and baking time are essentially in relation to each other, these two variables can be adjusted to produce similar products. Nevertheless, it should be mentioned that both higher temperatures and longer baking times in relation to the wall thickness should be individually adapted to the baked product to be produced. In addition, different degrees can be produced by the baking time and the heat applied. The baking degree refers to the color of the wafer, which becomes darker or lighter depending on the parameters of the applied heat and baking time.

Demolding can be done using compressed air, stripping, pins, suction cups or similar.

### Preferred Embodiments

The granules of the present invention consist of natural, preferably purely plant-based components comprising plant-based starch and plant-based flour. The granules have the following solid composition:

| | | |
|---|---|---|
| plant-based starch | 20-65 | wt % |
| plant-based flour | 10-55 | wt % |
| plant-based fat | 0.5-7 | wt % |
| and/or plant-based oil | | |
| optional additives | 0-35 | wt % |

wherein the ratio of plant-based starch to plant-based flour is 1:1.6-1:5 or 1.6:1-5:1 and wherein the granules have a residual moisture content of 10-50%, preferably 12-25%.

In some preferred embodiments, the plant-based starch is wheat starch.

In some embodiments, the flour is wheat flour, durum wheat flour, cracked wheat flour, spelt flour, rye flour, rye cracked flour, durum wheat flour, wheat semolina, durum wheat semolina, wheat middlings, corn flour, rice flour, rye flour, barley flour, oat flour and millet flour, tapioca flour, guar gum, xanthan gum, agar-agar, pectin, carrageenan, alginate, or locust bean gum, or a mixture thereof.

In some embodiments, the granules comprise rapeseed oil or nut oil.

The optional additives are comprised in the following embodiments:

In preferred embodiments, the granules further comprise magnesium.

In preferred embodiments, the granules further comprise sodium bicarbonate/baking soda.

In preferred embodiments, the granules further comprise plant-based lecithin.

In preferred embodiments, the granules further comprise caramel.

In preferred embodiments, the granules further comprise the enzyme preventase.

In some embodiments, the granules further comprise vinegar.

In some embodiments, the granules further comprise calcium propionate, sodium benzoate, calcium phosphate and butyl hydroxyanisole.

In some embodiments, the granules additionally comprise plant-based sugar substitutes: from xylitol (E 967), erythritol (E 968), sorbitol (E 420), mannitol (E 421), isomalt (E 953), maltitol (E 965), lactitol (E 966), stevia (E 960), vanilla sugar, powdered sugar.

In some embodiments, the granules further comprise caramel of xylitol (E 967), erythritol (E 968), sorbitol (E 420), mannitol (E 421), isomalt (E 953), maltitol (E 965), lactitol (E 966), stevia (E960), vanilla sugar, powdered sugar.

In some embodiments, the granules further comprise milk and/or plant-based milk.

In some embodiments, the granules further comprise egg and/or plant-based egg substitute.

In some embodiments, the granules further comprise plant-based butter and/or plant-based margarine.

In some embodiments, the granules additionally comprise wheat fibers and/or plant fibers, preferably bamboo fibers.

In some embodiments, mold growth of the produced granules or product can be counteracted. In some embodiments, the granules therefore comprise preservatives such as: E 220 sulfur dioxide/sulfurous acid, E 221 sodium sulfite, E 222 sodium hydrogen sulfite, E 223 sodium disulfite, E 224 potassium disulfite, E 226 calcium sulfite, E 227 calcium hydrogen sulfite, or E 228 potassium hydrogen sulfite. These preservatives are listed as food additives which, in addition to the classic benefits of preservatives, also counteract the degradation of colorants, vitamins and flavors through the influence of oxygen. This means that the general shelf life is maintained for longer.

In some embodiments, the granules are moldable. In other embodiments, the granules are rigid. The flexibility of the granules can be increased by adding glycerin.

The shape of the granules is variable. For example, the granules can be lenticular, cylindrical or pearl-shaped. The diameter of the granules is variable. The diameter of the granules can be 1-5 mm. In preferred embodiments, the diameter of the granules is 1-3 mm. In particularly preferred embodiments, the granules have a diameter of 2-3 mm. Exemplary diameters of the individual pieces of granules are 1 mm, 1.5 mm, 2 mm, 2.5 mm, 3 mm, 3.5 mm, 4 mm, 4.5 mm, 5 mm.

The granules can be injection molded into a food product, wafers, cookies, edible disposables, utility articles and packaging.

The present invention also relates to an edible bakery product made from the invention. The product can be a food product, an edible disposable product or an edible utility article.

The hardness of the wafer or baked product is variable. In some embodiments, the wafer or pastry is hard. In this case, the wall thickness of the product is very dense. In some embodiments, the wafer or cookie is airy, crisp and easy to bite through. The wall thickness has a lower density. This can be regulated by the residual moisture in the granulate or in the plasticized mass in the injection molding machine.

### EXAMPLES

The present invention is described in detail by the following non-limiting examples.

### Example 1: Preparation of the Granules

The raw material for the granulate consisted of:
Starch: 5 kg
Wheat flour: 2 kg
Sugar: 1 kg
Coconut fat: 50 g
Salt: 150 g
Baking soda: 40 g
Magnesium stearate: 10 g
Caramel: 10 g
Water: 4 Liters

The starting material was stirred in a mixer to form a mixture, first separating the solid components from the liquid components, and then mixing both mixtures until all components of the final mixture were well blended (approx. 10-15 min).

The still somewhat powdery mass was then fed directly into an extruder. This drew in the mass, compacted and plasticized it under energy supply and at the same time ensured a homogeneous mixture. The heated channel of the screw conveyor was heated with five heating elements (in the following order: 40° C.-80° C.-100° C.-60° C.-21° C. and fed the mass to the nozzles and pressed the mass out. In this way, the mass was formed into strands and cooled on a conveyor belt by fans. The strands produced were then cut into granules using a rotating blade. The blade passed through brushes that cleaned it before cutting. This produced a lenticular granulate. The granulate then hardened for 2 days and was finally packaged.

### Example 2: Preparation of the Granules

The raw material for the granulate consisted of:
Starch: 2 kg
Wheat flour: 5 kg
Sugar: 1.5 kg
Coconut fat: 500 g
Salt: 100 g
Baking soda: 20 g
Magnesium stearate: 10 g
Caramel: 15 g
Water: 4.4 Liters

The starting material was mixed in a mixer until all components of the mixture were well blended (approx. 5-10 min).

The still powdery mass was then fed directly into an extruder. This drew in the mass produced, compacted and plasticized it under energy supply and at the same time ensured a homogeneous mixture. The heated channel of the screw conveyor was heated with five heating elements (in the following order: 45° C.-75° C.-100° C.-60° C.-20° C.) and fed the mass to the nozzles and pressed the mass out. In this way, the mass was formed into strands and cut into granules by a rotating blade directly at the outlet. The blade passed through brushes that cleaned it before cutting. This produced a pearl-shaped granulate. The granulate then hardened for 1 day using a dehumidifier and was finally packaged.

### Example 3: Production of an Injection Molded Product from the Granules of the Invention

The raw material for the granulate consisted of:
Starch: 2 kg
Wheat starch: 5 kg
Soy lecithin 0.4 kg
Sugar: 1.5 kg
Coconut fat: 500 g
Salt: 100 g
Baking soda: 20 g
Magnesium Stearate: 10 g
Caramel: 15 g
Water: 4.4 Liters

The still powdery mass was fed directly into an extruder. This drew in the mass produced, compacted and plasticized it under energy supply and at the same time ensured a homogeneous mixture. The heated channel of the screw conveyor was heated with five heating elements (in the following order: 40° C.-80° C.-100° C.-60° C.-21° C. and fed the mass to the nozzles and pressed the mass out. In this way, the mass was formed into strands and cooled on a conveyor belt by fans. The strands produced were then cut into granules using a rotating blade. The blade passed through brushes that cleaned it before cutting. This produced a lenticular granulate. The granulate then hardened for 2 days and was finally packaged. The residual moisture in the granules was 12-25%.

The granulate produced was then fed into the rotating screw of an injection molding machine via the hopper. The granulate was conveyed by the rotation towards the tip of the screw. This created friction heat by cutting and shearing the granulate, which, together with the heating of the cylinder in which the screw rotates, ensured the melting and further homogenization of the granulate. A 2-cavity mold with an underfloor sprue was available. The mold was heated to 150° C., the nozzle to 45° C., the barrel to approx. 70° C. to 80° C. and the feed to 45° C.

As the process progressed, the melt accumulated at the tip of the screw where the outlet nozzle is located, which was closed at the time. This created pressure on the screw. As the screw is axially movable, it unscrewed backwards out of the molten mass under this pressure, similar to a corkscrew. The backward movement of the screw was slowed down by a hydraulic cylinder or by means of electrical control. This created back pressure in the molten mass. This back pressure combined with the rotation of the screw compressed and homogenized the melt.

Thereafter, granules sufficient for the volume of the workpiece to be produced accumulated in front of the nozzle thereby stopping the rotation of the screw and ending the dosing process. At the same time, the screw was actively relieved in order to decompress the melt.

The injection unit then approached the clamping unit. It was pressed on with the nozzle and the screw was simultaneously pressurized at the rear. This created a pressure of 1,200 bar, which was used to force the melt through the nozzle and the sprue system of the mold into its cavity.

The material hardened in the mold and finally solidified. This caused the ejector side of the mold to open. Pins penetrated the cavity of the mold and pushed the molded part out of the mold (forced demolding). It then fell into a waiting container. Finally, the product was stacked and packaged.

1. Granules consisting of plant-based ingredients comprising:

| Plant-based starch | 20-65 | wt %, |
|---|---|---|
| Plant-based flour | 10-55 | wt %, |
| Plant-based fat | 0.5-7 wt %, and | |
| and/or Plant-based oil | | |
| Optional additives | 0-35 | wt %, |

wherein the ratio of plant-based starch to plant-based flour is 1:1.6-1:5 or 1.6:1-5:1 and wherein the granules have a residual moisture content of 10-50%.

2. The granules according to claim 1, wherein the total amount of plant-based starch and plant-based flour is at least 65% by weight of the total mass of solids.

3. The granules according to claim 1, wherein the ratio of plant-based starch to plant-based flour is 1:2.5 or 2.5:1.

4. The granules according to claim 1, wherein the optional additives comprise sugar, a xylitol-containing sweetener, salt, baking soda, plant-based stearates, caramel, soy lecithin, and preventase.

5. The granules according to claim 1, wherein the plant-based starch is a native starch and comprises wheat starch, potato starch, corn starch, tapioca starch or starch from cassava, tuberous bean, batate, yam, tuberous pawpaw, arakacha, tuberous wood sorrel, tuberous nasturtium, ulluco, East Indian arrowroot, arrowroot, achira, taro, tannia, white water lily, yellow water lily or chayote, sweet potato starch, gesture starch, rye starch, sorghum starch, tritichale starch, modified starch, or a mixture thereof; preferably wheat starch, potato starch, corn starch, rice starch, tapioca starch, or a mixture thereof.

6. The granules according to claim 1, wherein the plant-based flour comprises wheat flour, rice flour, spelt flour, rye flour, barley flour, oat flour, millet flour, tapioca flour, almond flour, guar gum flour, carob flour, or a mixture thereof.

7. The granules according to claim 1, wherein the plant-based oil and/or plant-based fat is hardened plant-based oil or hardened plant-based fat.

8. The granules according to claim 1, wherein the granules are formed by injection molding.

9. The granules according to claim 8, wherein the injected-molded granules are subsequently formed into a wafer or a pastry product.

10. (canceled)

11. Method for the production of wafers and pastry products comprising the steps of:
a) injecting into an injection molding machine filling the granules according to claim 1,
b) injection molding the granules into a desired shape for each wafer and each pastry product.

12. The method according to claim 11, wherein natural aromas, flavorings and/or natural food-safe colorings are added to the granules before the injecting step a).

13. (canceled)

14. The method according to claim 11, wherein the wafers and pastry products produced are edible and are fully biodegradable and compostable.

15. The method according to claim 11, wherein the pastry product is a cookie.

16. The granules according to claim 1, wherein the granules have a residual moisture content of 12-25%.

17. The method according to claim 11, wherein the wherein the wafers and pastry products produced are formed into a shape that acts as a carrier for a food product.
